(19) United States
(12) Patent Application Publication
(10) Pub. No.: US 2025/0012995 A1
(43) Pub. Date: Jan. 9, 2025

(54) FIBER OPTIC ENCLOSURE WITH INTEGRATED FIBER TUBES

(71) Applicant: CommScope Technologies LLC, Hickory, NC (US)

(72) Inventors: Rudy MUSSCHEBROECK, Wemmel (BE); Marc DR VAN HECK, Leuven (BE); Craig A. CULWELL, Auburn, CA (US)

(73) Assignee: CommScope Technologies LLC, Hickory, NC (US)

(21) Appl. No.: 18/705,884

(22) PCT Filed: Oct. 31, 2022
(86) PCT No.: PCT/US2022/048432

§ 371 Date: Apr. 29, 2024

Related U.S. Application Data
(60) Provisional application No. 63/273,340, filed on Oct. 29, 2021.

(51) Int. Cl. G02B 6/44; G02B 6/36

(52) U.S. Cl. CPC G02B 6/4444; G02B 6/3696; G02B 6/4459

(57) ABSTRACT

The present disclosure relates to a telecommunication enclosure including a housing and fiber tubes integrated with the housing. The fiber tubes can be integrated with a base of the housing. The fiber tubes can also be integrated with a carrier body of the housing that mounts within an opening of the housing (e.g., an opening in a base of the housing).

### CROSS-REFERENCE TO RELATED APPLICATION

This application is being filed on Oct. 31, 2022 as a PCT International Patent Application and claims the benefit of U.S. Patent Application Ser. No. 63/273,340, filed on Oct. 29, 2021, the disclosure of which is incorporated herein by reference in its entirety.

### TECHNICAL FIELD

The present disclosure relates to telecommunication enclosures for fiber optic systems.

### BACKGROUND

Different architectures and systems have been developed for facilitating the deployment of fiber optic networks. One type of system architecture can be referred to as a blown fiber system. An example blown fiber system can include a conduit through which one or more blown fiber tubes are routed at a first date. The blown fiber tubes and the conduit extend between a first location (e.g., a more centralized location such as cabinet, hub, etc.) and a second location (e.g., a location closer to a periphery of the network than the first location and often in the vicinity of subscriber locations). At a second date, when it is desired to provide fiber optic service to subscribers near the second location, optical fibers can be blown through the pre-installed blown fiber tubes from the first location to the second location.

### SUMMARY

Certain aspects of the present disclosure relate to features for reducing or eliminating the reliance on cable sealing gel for sealing locations where fiber tubes such as blown fiber tubes enter a telecommunication enclosure. In certain examples, fiber tubes such as blown fiber tubes can be integrated with a plastic component of a housing of the telecommunication enclosure. In certain examples, the component may include a base of the housing or a part that mounts within an opening of the housing.

Another aspect of the present disclosure relates to a telecommunication enclosure including a housing having a first housing piece. The telecommunication enclosure also includes a fiber tube carrier that mounts to the first housing piece. The fiber tube carrier carries a plurality of fiber tubes through which optical fibers can be deployed by blowing. The fiber tube carrier includes a carrier body having a molded plastic construction. The fiber tubes extend through a thickness of the carrier body with inner tube portions of the fiber tubes extending inwardly from an inner side of the carrier body and outer tube portions extending outwardly from an outer side of the carrier body. The fiber tubes are sealed with respect to the carrier body without sealing gel and are configured such that when the fiber tube carrier is mounted to the first housing piece the inner tube portions extend within an interior of the housing and the outer tube portions extend outside the interior of the housing. A seal is defined between the carrier body and the first housing piece when the fiber tube carrier is mounted to the first housing piece. In one example, the first housing piece can form a housing cover and the fiber tube carrier can include a base of the housing to which the cover mounts. In another example, the first housing piece can form a base of the housing and the fiber tube carrier can mount within an opening defined by the base.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 depicts a blown fiber system in accordance with the principles of the disclosure prior to a fiber being deployed through the system;

FIG. 2 depicts the blown fiber system of FIG. 1 after an optical fiber has been deployed through the system and routed into a telecommunication enclosure in accordance with the principles of the present disclosure;

FIG. 3 is an exploded view of an example telecommunication enclosure in accordance with the principles of the present disclosure;

FIG. 4 is a bottom view of the telecommunication enclosure of FIG. 3;

FIG. 5 is an end view of an example fiber tube carrier in accordance with the principles of the present disclosure that can be mounted in sealed relation within one of the openings through the base of the telecommunication enclosure of FIGS. 3 and 4;

FIG. 6 is a cross-sectional view taken along section line 6-6 of FIG. 5 showing the fiber tube carrier of FIG. 5 mounted within an opening defined by the base of the telecommunications enclosure of FIGS. 3 and 4;

FIG. 7 depicts another telecommunication enclosure in accordance with the principles of the present disclosure;

FIG. 8 is a bottom view of the telecommunication enclosure of FIG. 7; and

FIG. 9 is a cross-sectional view taken along section line 9-9 of FIG. 8.

### DETAILED DESCRIPTION

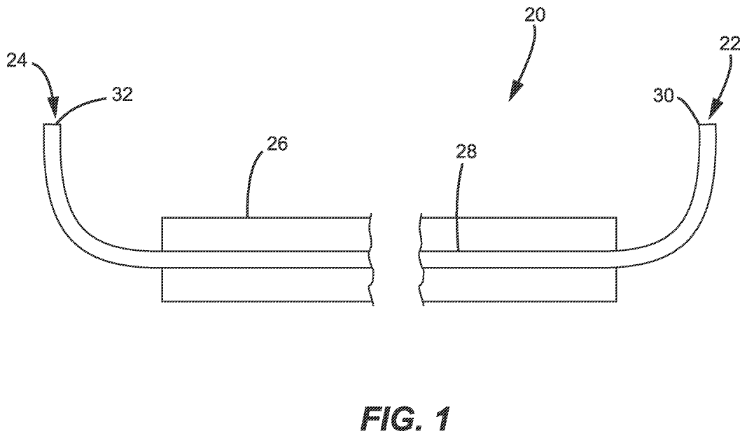

FIG. 1 depicts an example blown fiber system 20 in accordance with the principles of the present disclosure prior to optical fibers being deployed through the system. The system 20 includes a first location 22 and a second location 24. A conduit 26 (e.g., an underground conduit) is routed at least partially between the first and second locations 22, 24. The conduit 26 contains at least one fiber tube 28 routed through the conduit 26 between the first and second locations 22, 24. In one example, the fiber tube 28 is a blown fiber tube configured for allowing optical fibers to be blown therethrough to deploy the optical fibers. In one example fiber tube 28 has an outer diameter of about 7 millimeters (mm) and an inner diameter of about 4 mm. In another example fiber tube 28 has an outer diameter of about 5 mm and an inner diameter of about 3 millimeters.

In one example, the first location 22 is more centrally located in the network than the second location 24 and the second location 24 is closer to a periphery of the network than the first location 22. In one example, the first location 22 is a fiber distribution point such as a cabinet or hub and the second location is in the vicinity of subscriber locations or future subscriber locations. Typically, a plurality of the fiber tubes are routed through the conduit for providing fiber optic service to different locations along the length of the conduit 26.

The fiber tube 28 includes a first end 30 that can be accessed at the first location 22 and a second end 32 that can be accessed adjacent the second location 24. It will be appreciated that the fiber tube 28 can also be routed through or to additional structures such as enclosures/terminals, hand holes and the like.

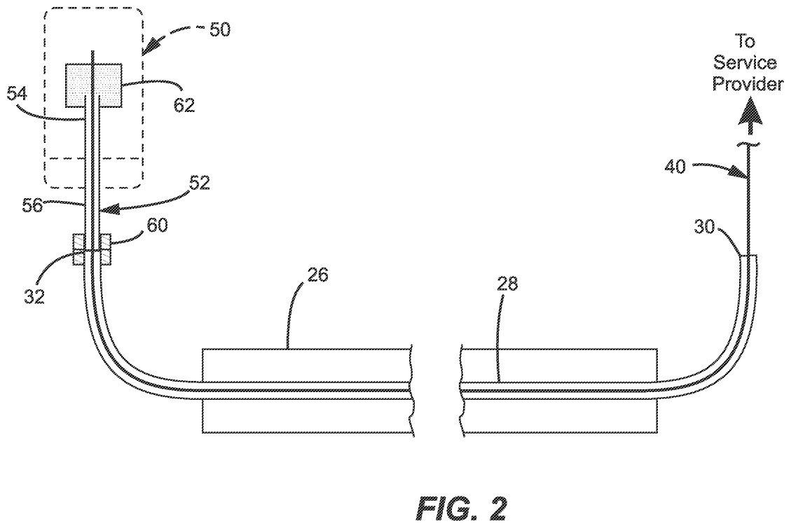

FIG. 2 shows the system 20 at a date after initial deployment in which an optical fiber 40 has been routed through the fiber tube 28 and into a telecommunication enclosure 50 installed at the second location 24. The telecommunication enclosure 50 can contain fiber optic components such as fiber storage structures, splice trays, passive optical power splitters and wavelength division multiplexers. At the enclosure 50, the optical fiber 40 can be optically coupled to the input of a passive optical splitter having outputs that are optically connected to optical fibers routed to subscriber locations (e.g., through blown fiber tubes integrated with the enclosure, or via optical cables routed into the enclosure or coupled to the enclosure at hardened adapter ports). In other examples, the optical fiber can be spliced directly to an optical fiber routed to a subscriber location via a blown fiber tube or through a cable routed into the enclosure or coupled to the enclosure at a hardened adapter port. The enclosure 50 includes a fiber tube 52 integrated with the enclosure 50. The fiber tube 52 includes an inner tube portion 54 within an interior of the enclosure 50 and an outer tube portion 56 that extends outside the enclosure 50. The outer tube portion 56 is coupled to the second end 32 of the fiber tube 28 in a sealed manner by a tube coupler 60. The optical fiber 40 extends through the fiber tube 52 into the interior of the enclosure 50. A gas blocking element 62 can be mounted at the end of the inner tube portion 54 to prevent air or other gas from entering the enclosure 50) through the fiber tubes 28, 52. The optical fiber 40 extends through the gas blocking element 62 and is sealed relative to the gas blocking element 62.

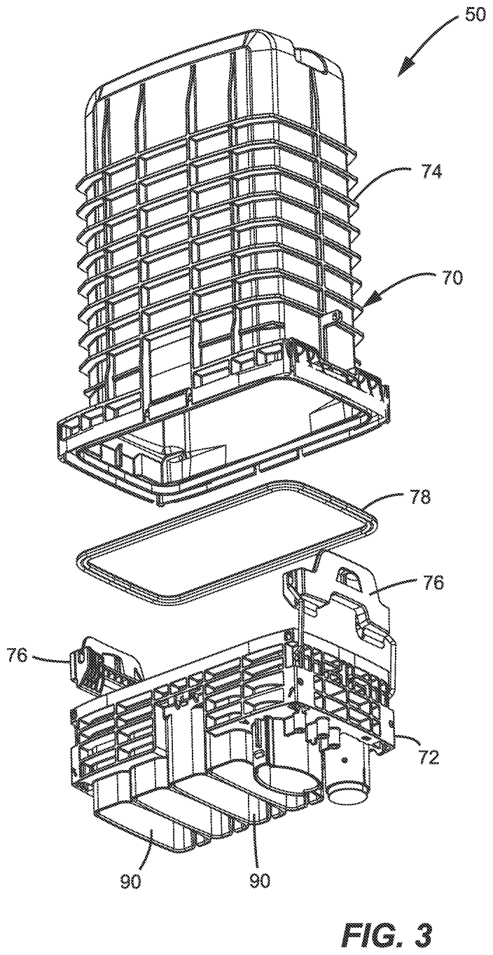

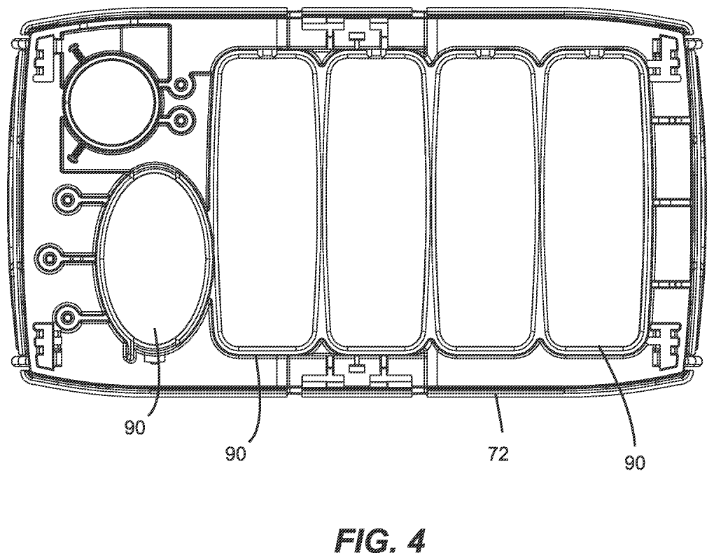

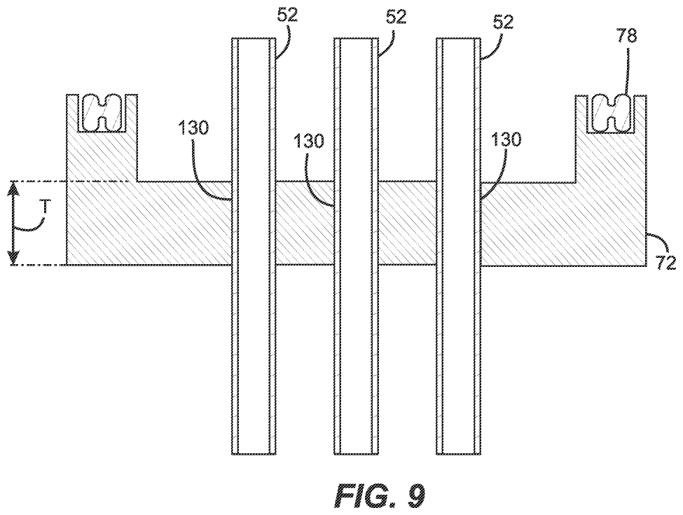

FIGS. 3 and 4 depict an example configuration for the enclosure 50. As depicted, the enclosure 50 includes a housing 70 having a base 72 and a cover 74 (e.g., a dome). The base and the cover can be coupled together in a manner that allows the base and the cover to be detached from one another to access the interior of the housing 70. For example, latches 76 can be provided for latching the base 72 and the cover 74 together. In other examples, clamps or fasteners, such as bolts or other structures, can be used to secure the base 72 and the cover 74 together. A perimeter seal 78 is preferably provided for sealing between the base 72 and the cover 74. In one example, the perimeter seal 78 is a gasket having an elastomeric construction. As shown at FIG. 9, the gasket can have an H-shaped cross-sectional profile. In other examples, other profiles such as a circular profile (e.g., an o-ring), a square profile, rectangular profile, an elliptical profile or other profiles can also be used.

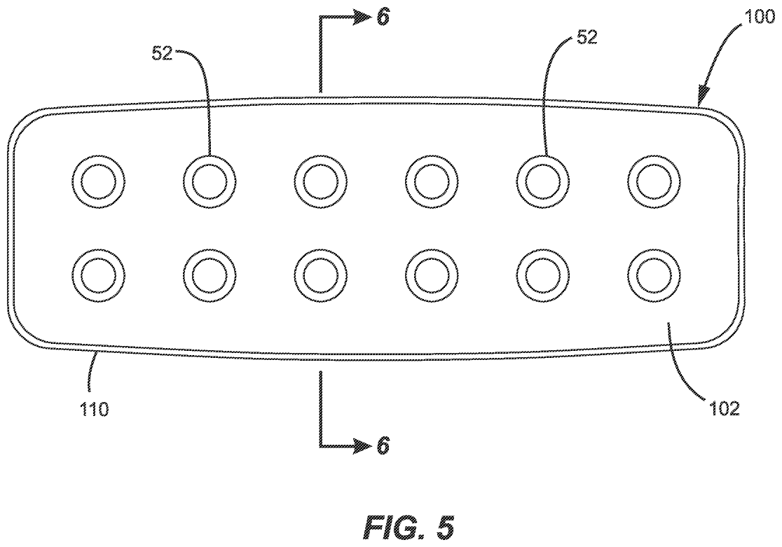

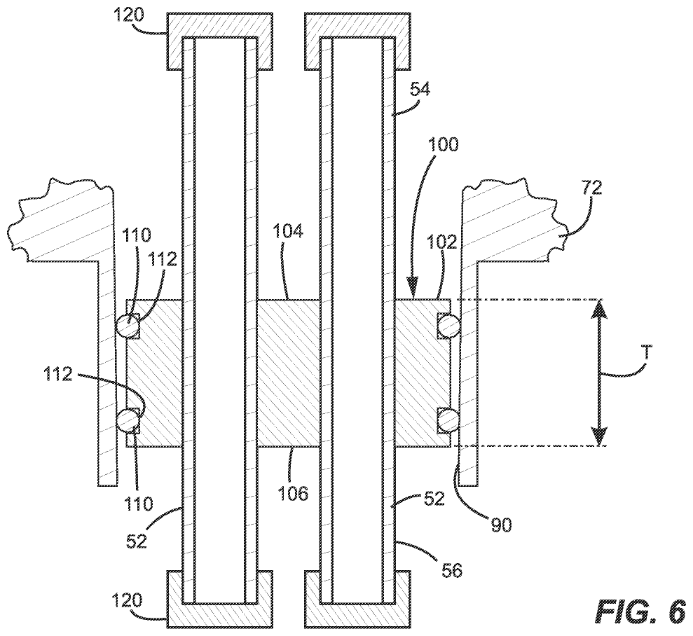

The base 72 defines a plurality of openings 90 for allowing optical fibers to be routed into the interior of the housing 70. In certain examples, the openings 90 can be configured for receiving cable sealing modules including cable sealing gel for sealing optical cables routed into the housing 70. In accordance with aspects of the present disclosure, at least one or some of the openings 90) can be configured for receiving a fiber tube carrier 100 (see FIGS. 5 and 6) in accordance with the principles of the present disclosure. The fiber tube carrier 100 carries a plurality of the fiber tubes 52 through which optical fibers 40 can be deployed (e.g., by blowing or other method such as pushing or pulling). The fiber tube carrier 100 includes a carrier body 102 having a molded plastic construction. The fiber tubes 52 extend through a thickness T of the carrier body 102 with the inner tube portions 54 extending inwardly from an inner side 104 of the carrier body and the outer tube portions 56 extending outwardly from an outer side 106 of the carrier body 102. The fiber tubes 52 are sealed with respect to the carrier body 102 (e.g., at the pass-through location through the thickness T of the carrier body 102) without requiring the use of cable sealing gel. A seal is defined between the carrier body 102 and the base 72 when the fiber tube carrier 100 is mounted within one of the openings 90. The fiber tube carrier 100 can be secured within the corresponding opening 90 mechanically by structures such as a latch, fasteners, clamps, or the like.

In one example, the seal defined between the carrier body 102 and the base 72 when the fiber tube carrier is mounted within its corresponding opening 90 is formed by a seal that extends around a periphery of the carrier body 102. In one example, the seal can include an elastomeric seal such as a gasket 110. In certain examples, more than one gasket can be used. As shown at FIG. 6, two gaskets 110 are shown mounted within grooves 112 defined about the periphery of the carrier body 102 four providing sealing between the carrier body 102 and the base 72 when the carrier body 102 is mounted within its corresponding opening 90). In certain examples, the fiber tubes 52 are initially devoid of any fibers and the inner and outer end portions 54, 46 of the fiber tubes 52 can be enclosed by sealing caps 120. The sealing caps 120 can be removed when it is desired to pass optical fibers through the fiber tubes 52, but function to prevent air or moisture from entering the enclosure prior to utilization of the fiber tubes 52 for routing optical fibers into the housing 70.

In certain examples, the molded plastic construction of the carrier body 102 is significantly harder than the material forming the gasket 110 and the elastomeric material typically used to provide cable sealing (e.g., thermoplastic elastomeric gel or silicone gel). In certain examples, the molded plastic construction of the carrier body 102 has a durometer of at least 80 Shore A, or at least 90 Shore A, or at least 100 Shore A.

In certain examples, the fiber tubes 52 are bonded to the carrier body 102 to concurrently provide mechanical fixation and sealing between the fiber tubes 52 and the carrier body 102. In one example, the carrier body 102 can be pre-molded defining openings for receiving the individual fiber tubes 52, and the fiber tubes 52 can be bonded within the openings by an adhesive material such as epoxy. In another example, the carrier body 102 can be molded about the fiber tubes 52 during molding of the carrier body 102, and the fiber tubes 52 are bonded to the carrier body 102 as part of the molding process upon curing of the carrier body 102. In certain examples, the fiber tubes 52 are permanently attached to the carrier body (i.e., not intended to be removed from the carrier body).

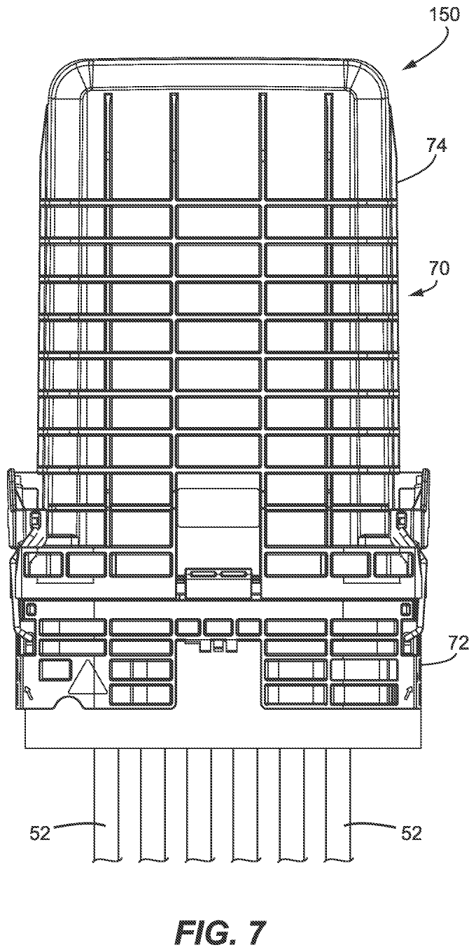

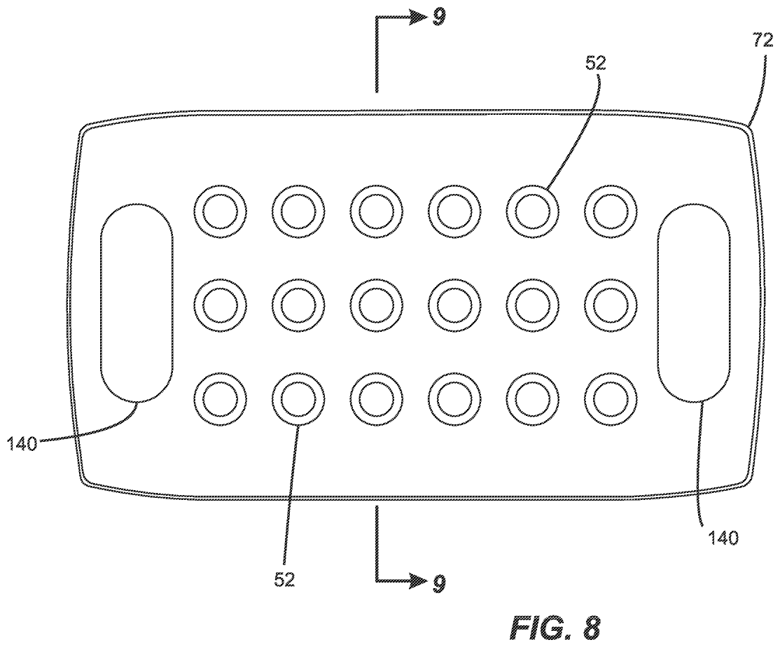

FIGS. 7-9 depict an alternative enclosure 150 in accordance with the principles of the present disclosure having the same configuration as the enclosure 50 of FIGS. 3 and 4 except the fiber tubes 52 have been directly integrated with the base 72 of the housing such that the base functions as the fiber tube carrier. For example, as shown in FIGS. 8 and 9, the fiber tubes 52 extend through a thickness T of the base 72 and are affixed within individual openings 130 defined by the base 72. It will be appreciated that the base 72 can have a molded plastic construction having a hardness of the type described above with respect to the carrier body 102. The fiber tubes 52 can be bonded to the base 72 to concurrently provide mechanical fixation of the fiber tubes 52 to the base 72 and sealing between the base 72 and the fiber tubes 52. The fiber tubes 52 can be permanently attached to the base 72. The base 72 can include additional openings 140 for receiving cable sealing modules adapted for allowing cables to be routed into the interior of the enclosure. In one example, the base 72 can be pre-molded defining openings for receiving the individual fiber tubes 52, and the fiber tubes 52 can be bonded within the openings 130 by an adhesive material such as epoxy. In another example, the base 72 can be molded about the fiber tubes 52 during molding of the base 72, and the fiber tubes 52 are bonded to the base 72 as part of the molding process upon curing of the base 72.

From the forgoing detailed description, it will be evident that modifications and variations can be made in the devices of the disclosure without departing from the spirit or scope of the invention.

What is claimed is:

1. A telecommunication enclosure comprising:
a housing including a first housing piece;
a fiber tube carrier the mounts to the first housing piece, the fiber tube carrier carrying a plurality of fibers tubes through which optical fibers can be deployed, the fiber tube carrier including a carrier body having a molded plastic construction, the fiber tubes extending through a thickness of the carrier body with inner tube portions of the fiber tubes extending inwardly from an inner side of the carrier body and outer tube portions extending outwardly from an outer side of the carrier body, the fiber tubes being sealed with respect to the carrier body without sealing gel and being configured such that when the fiber tube carrier is mounted to the first housing piece the inner tube portions extend within an interior of the housing and the outer tube portions extend outside the interior of the housing; and
wherein a seal is defined between the carrier body and the first housing piece when the fiber tube carrier is mounted to the first housing piece.

2. The telecommunication enclosure of claim 1, wherein the seal extends around a periphery of the carrier body.

3. The telecommunication enclosure of claim 1, wherein the seal includes a gasket.

4. The telecommunication enclosure of claim 3, wherein the gasket mounts on the carrier body.

5. The telecommunication enclosure of claim 1, wherein the molded plastic construction has a durometer of at least 80 Shore A, or at least 90 Shore A, or at least 100 Shore A.

6. The telecommunication enclosure of claim 1, wherein the fiber tubes are bonded to the carrier body.

7. The telecommunication enclosure of claim 1, wherein the fiber tubes are permanently attached to the carrier body.

8. The telecommunication enclosure of claim 1, wherein carrier body is molded about the fiber tubes during molding of the carrier body, and wherein the fiber tubes are bonded to the carrier body as part of the molding process upon curing of the carrier body.

9. The telecommunication enclosure of claim 1, wherein the fiber tube carrier forms a base of the housing, and wherein the first housing piece is a cover that mounts in sealed relation relative to the base.

10. The telecommunication enclosure of claim 1, wherein the cover has a dome-type configuration.

11. The telecommunication enclosure of claim 1, wherein the first housing piece is a base of the housing, wherein the housing also includes a cover that mounts in sealed relation relative to the base, and wherein the fiber tube carrier mounts within an opening defined by the base.

12. The telecommunication enclosure of claim 1, wherein the base defines a plurality of openings, and wherein the telecommunications enclosure includes a plurality of the tube carries which mount within corresponding ones of the openings.
